(19) United States
(12) Patent Application Publication
(10) Pub. No.: US 2024/0375426 A1
(43) Pub. Date: Nov. 14, 2024

(54) PRINTER USING ASH

(71) Applicant: TIMELESS GUARDIANS, Herve (BE)

(72) Inventor: Patrick SMETS, Herve (BE)

(21) Appl. No.: 18/285,974

(22) PCT Filed: Apr. 7, 2022
(86) PCT No.: PCT/EP2022/059318

§ 371 Date: Oct. 6, 2023

(30) Foreign Application Priority Data
Apr. 7, 2021 (FR) FR2101786

(51) Int. Cl. B43K 8/00; B05B 7/24; B05B 12/14

(52) U.S. Cl. CPC B43K 8/006; B05B 7/2408; B05B 12/1418

(57) ABSTRACT

This device comprises a control panel (23) in which said representation is digitally stored, a platen (9) of flat shape designed to accept a support, such as a sheet of paper, an airbrush printing tool (7) designed for airbrush printing (7), comprising a hopper and a reservoir (21) designed to take ash and ink that are to be mixed by the hopper, the airbrush printing tool (7) being designed to be able to create airbrush prints using the mixture contained in the reservoir and supplied by the hopper, the airbrush printing tool (7) furthermore being mounted with the ability to move relative to the platen (9) along three orthogonal axes and being numerically controlled into its positions along the three axes by the control panel (23) so as to allow the digital representation to be airbrush printed onto the support.

### FIELD OF THE INVENTION

The present invention relates to airbrush printing devices.

The present invention aims to constitute an airbrush printing device which can accept ash and mix it with ink to obtain a mixture which will be vaporised on a support, such as a sheet of paper for printing a representation.

### PRIOR ART

Devices for airbrush printing are known, but current solutions are inadaptable in the composition of ink used and do not allow the incorporation of ash into this ink.

US 2019/176184 A1 discloses a device and a method for a painting machine. The painting machine can comprise an end gripper controlled by personalised software and an autonomous fluid circulation system. The personalised control software can be capable of coordinating the handling of a gripper on n axes. Examples of end grippers can include an inkjet head, a brush, an airbrush printing tool or any tool suitable for applying ink, paint, colour and/or texture onto a surface. For example, a gripper can use oil-based ink or ultraviolet drying ink.

However, US 2019/176184 does not allow the use of ash and mentions nothing regarding the use of ash.

### SUMMARY OF THE INVENTION

The invention aims to provide an alternative solution to current devices, and to provide a printing device capable of accepting, mixing and using ash.

In view of the above, the invention aims for a device for airbrush printing a representation onto a support, such as a sheet of printing paper, comprising a control panel in which said representation is digitally stored, a platen of flat shape designed to accept the support, an airbrush printing tool designed for airbrush printing comprising a hopper and a reservoir designed to take ash and ink to be mixed by the hopper, the airbrush printing tool being designed to be able to create airbrush prints using the mixture contained in said reservoir and supplied by the hopper, the airbrush printing tool furthermore being mounted with the ability to move relative to the platen along three orthogonal axes and numerically controlled in its positions along said three axes by the control panel to allow the airbrush printing of the digital representation onto the support.

The hopper is a dosing hopper designed to be able to adjust the concentration of ash and ink in the reservoir.

A dosing hopper allows to automatically adapt the concentration of ask and ink according to the final appearance sought.

Advantageously, the dosing hopper furthermore comprises a funnel-shaped container, a first and a second reservoir, the first reservoir being configured to take ink, the second reservoir being configured to take ash, the first and second reservoir being located upstream from the funnel-shaped container.

This device allows to easily supply the dosing hopper with two compounds, or mediums, or more specifically, the medium comprising ink and the medium comprising ash.

Preferably, the dosing hopper furthermore comprises a membrane disposed so as to supply a first and a second chamber, the first chamber being connected to the first reservoir, the second chamber being connected to the second reservoir.

These two chambers allow to dosing hopper to contain the two mediums separately before they are mixed.

A reservoir configured to take the mixture is preferably supplied downstream from the funnel-shaped container.

Preferably, the first chamber is connected to the reservoir by a first dosing means, and/or the second chamber is connected to the reservoir by a second dosing means.

The first and/or the second dosing means allows to supply the reservoir with the desired quantities of each medium.

Preferably, the first dosing means for the ink comprises the at least one from among a volumetric doser, a gravimetric doser, a piston doser, a membrane doser, a valve doser and a peristaltic doser.

Preferably, the second dosing means for the ash comprises at least one from among a powder dosing system, preferably a worm screw, a volumetric doser, a gravimetric doser, and when the ash is in a liquid, paste or gelatine medium, the second dosing means comprise at least one from among a volumetric doser, a gravimetric doser, a piston doser, a membrane doser, a valve doser and a peristaltic doser.

Advantageously, the dosing hopper is connected to control means configured to control the concentrations of ink and ash in the final mixture, more specifically in which the first and second dosing means are configured to be controlled by the control means.

The control means allow to automatically adjust the concentrations of ink and ash in the final mixture.

Advantageously, a mixer disposed downstream from the dosing hopper and upstream from the reservoir can be supplied.

Advantageously, the reservoir is a cylinder or a pipe connected to a nozzle. For example, the airbrush printing tool is configured to be able to be moved horizontally and vertically along lead screws and using in-position servo commands sent by the control panel.

Advantageously, elements for guiding in translation are coupled to at least one of the lead screws.

According to an embodiment, three orthogonal lead screws each extend respectively along one of the three orthogonal axes, and each of said lead screws is coupled to three drive motors designed for the rotating of said lead screws.

In an embodiment, the motors are controlled by a control circuit module having an electronic board, coupled to the control panel.

Advantageously, the lead screws are held in their respective axial positions thanks to aluminium frame structural supports.

The device can furthermore provide that the platen is designed to take the support, such as printing paper, preferably, in standard format of 297 millimetres×420 millimetres, or the at least one from among flat objects, as well as on three-dimensional objects and on objects obtained by 3D printing.

Preferably, a cable path designed to hold the electric cables of the motors at a distance from the platen, such that said cables do not come into contact with said platen during transverse movements of each motor and of its lead screw along the orthogonal transverse axes of the other lead screws, said movements being generated by the rotations of said other lead screws to move the hopper for airbrush printing.

The invention also relates to a device in which the frames comprise a substantially horizontal frame, and the device furthermore comprises a support for the platen comprising five aluminium profiles bolted to said horizontal frame.

Preferably, the platen is designed to take absorbent supports like paper, textile, tiles, wood, terracotta, etc., and non-absorbent supports like metal, plastics, glass, ceramic.

According to another aspect, the use of the device is proposed to airbrush print a representation onto a support, such as a sheet of printing paper, onto a flat or three-dimensional object, an absorbent or non-absorbent support, with an ash and ink mixture.

According to another aspect, a method is proposed for airbrush printing with the device of the present invention, the method comprising the steps of supplying a digital image of a representation, supplying a support, supplying ink in the first reservoir, supplying ash in the second reservoir, starting the printing process by the control panel.

Such a method allows to obtain a print of the graphic representation on a support with an ash and ink mixture where concentrations of ash and of ink have been automatically adjusted.

Advantageously, the method furthermore comprises the step of grinding ash with the grinding means.

This allows to adjust the dimensions of the grains on the final print.

Preferably, the method furthermore comprises the step of mixing the ash with a solvent or water and optionally, a binder to supply a liquid, paste or gelatine medium.

Advantageously, the step of starting the printing process furthermore comprises a step of adjusting the ash and/or ink concentrations in the final mixture.

According to another aspect, it is proposed to supply a dosing hopper to print an ash and ink mixture in at least one from among an airbrush printing tool, an inkjet system, a pad printing system, a flexography system, the hopper being configured to separately take ink and ash and to adjust their concentration in the mixture, the dosing hopper comprising a substantially cone-shaped container, a first reservoir configured to take ink, a second reservoir configured to take ash, a first and a second chamber separated by a membrane in the container, a reservoir located downstream from the container, first dosing means connecting the first chamber to the reservoir, second dosing means connecting the second chamber to the reservoir, the first and second dosing means being controlled by control means for controlling the concentrations of ash and ink.

The dosing hopper according to the present invention can also be used in other printing technologies where it is desirable to print with an ash and ink mixture, and where the concentrations of ash and ink can be automatically adjusted during the printing process.

Advantageously, the first dosing means for the ink comprises the at least one from among a volumetric doser, a gravimetric doser, a piston doser, a membrane doser, a valve doser and a peristaltic doser.

Preferably, the second dosing means for ash comprises at least one from among a powder dosing system, preferably a worm screw, a volumetric doser, a gravimetric doser, and when ash is comprised in a liquid, paste or gelatine medium, the second dosing means comprise at least one from among a volumetric doser, a gravimetric doser, a piston doser, a membrane doser, a valve doser and a peristaltic doser.

Even more preferably, the dosing hopper is connected to control means, configured to control the concentrations of ink and ash in the final mixture, more specifically in which the first and the second dosing means are connected to the control means.

Advantageously, the dosing hopper furthermore comprises a mixer upstream from the reservoir.

According to another aspect, a computer program is proposed comprising instructions which make the device according to the invention execute the steps of the method according to the invention.

According to another aspect, a support which can be read by a computer is proposed, on which the computer program is recorded.

### BRIEF DESCRIPTION OF THE DRAWINGS

The invention will be best understood in the detailed study of an embodiment described by the accompanying drawings, in which:

FIG. 1 represents a printing device as a front view.

FIG. 2 represents the device as a rear view.

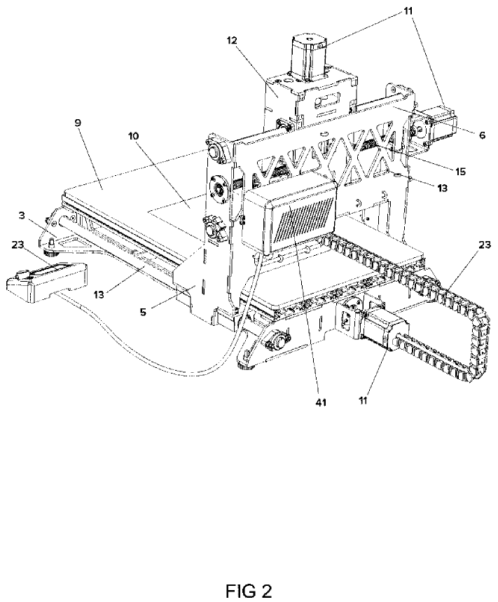

FIG. 3 represents the device as an exploded front view.

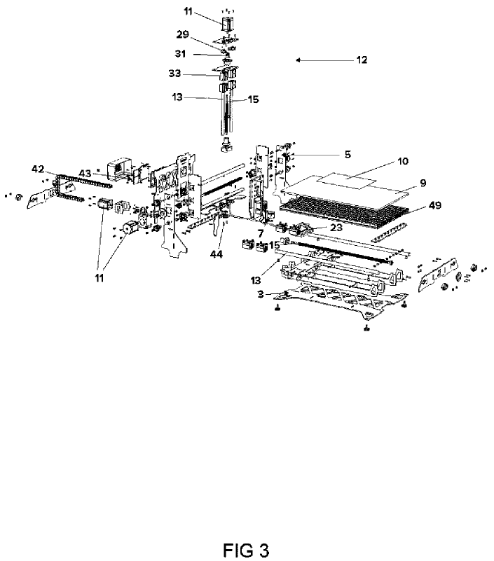

FIG. 4 represents the device as an exploded rear view.

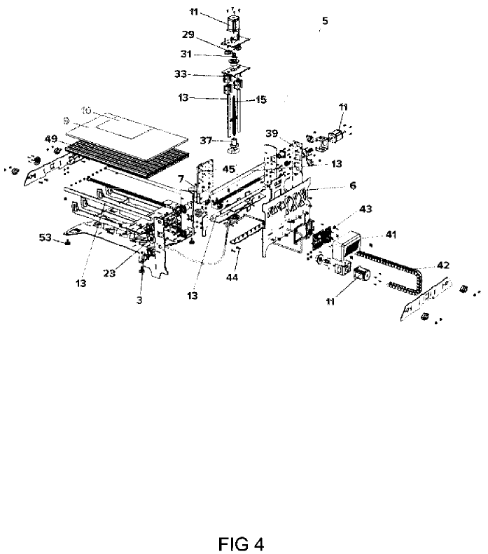

In the drawings, one same reference has been attributed to one same element or to one similar element.

### DETAILED DESCRIPTION OF THE FIGURES

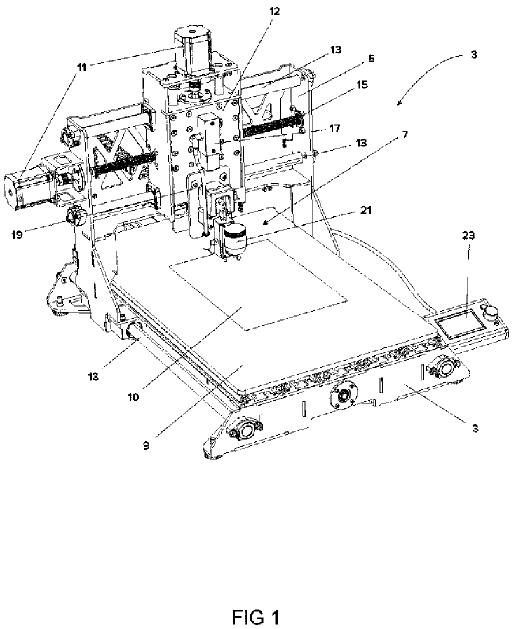

FIG. 1 illustrates an airbrush printing device 1 according to the invention.

The printing device 1 allows the airbrush printing of a representation, for example, on a sheet of printing paper 10. The paper must be of high quality for a better result.

It comprises a control panel 23 in which the representation is digitally stored, for example in an internal memory or via a remote server, such that the control panel 23 can supply this representation to the rest of the machine which will use it to create the print. The controls of the control panel 23 allow the user to select the task chosen on the website of the company, which can thus either sell the device 1, or sell the service for its use using a downloaded representation. The service supplied creates the ready-for-use mixed ink cylinders. The colours cannot be mixed directly and must be deposited in separate layers. The images with shades of one colour, in particular grey, are created in monochrome, therefore created using one same mixture.

The device 1 comprises a platen 9 of flat shape. It is designed to accept the sheet of paper which is disposed on top of it. The platen 9 indeed supplies the device 1 with a flat surface, which is essential to paint on.

The device can provide, for example, that the platen is designed to take printing paper in the standard format of 297 millimetres×420 millimetres.

The device 1 also comprises an airbrush printing tool 7 which is designed for airbrush printing, using the representation supplied by the control panel.

The triggering of the airbrush printing tool 7 can use a stepper motor to activate an air pipe which it comprises and to vaporise this air with the mixture onto the paper.

The airbrush printing tool 7 uses paint and compressed air to create printed images on the sheet using the representation.

The airbrush printing tool 7 has, contrary to known printers, a hopper, and a reservoir 21 designed to take ash and ink to be mixed by the hopper.

The ash allows to create beautiful, bespoke images thanks to the device. The ash airbrush printing tool 7 gives to the final image, a distinct, soft and unique, slightly hazy effect to each image. Furthermore, the incorporation of ash gives a poetic note to the work obtained, this ash being able to be in line with the representation itself. For example, a plant can be represented, by incorporating ash coming from the cremation of this same plant there, or also a landscape or a still life, by incorporating some ash obtained from cremations of the elements represented there.

The imagination of the user artist of the device 1 can bring themselves to use other types of ash that they will find poetic in the device 1. The user can then frame the result obtained.

The airbrush printing tool 7 is designed to be able to create airbrush prints using the mixture contained in said reservoir and supplied by the hopper.

The reservoir has, for example, the shape of a cylinder. This cylinder is reusable. It can furthermore be removably mounted on the airbrush printing tool 7, such that when the special ink mixture is poured into the hopper of the cylinder, this cylinder can be at least partially used on at least one portion of the sheet, before being swapped with another cylinder supplying another mixture, in particular if the images require several layers in different colours, as the device 1 cannot mix the colours automatically.

The airbrush printing tool 7 is furthermore mounted with the ability to move relative to the platen 9 along three orthogonal axes, namely two horizontal axes (anterior/posterior and left/right), a vertical ascending axis.

The airbrush printing tool 7 is thus capable of being moved relative to the sheet, from right to left and from the front to the rear to project the ink and ash mixture on it, and from top to bottom to be positioned at the correct distance from it.

For thus, the airbrush printing tool 7 is numerically controlled in its positions along said three axes by the control panel 23 to allow the airbrush printing of the digital representation on the sheet of paper to be printer 10.

Preferably, the hopper is a dosing hopper designed to be able to adjust the concentration of ash and ink in the reservoir. A dosing hopper allows the adjustment of concentration of the mixture according to preconfigured parameters.

For example, the airbrush printing tool 7 is configured to be able to be moved horizontally and vertically along lead screws 15 and using in-position servo commands sent by the control panel 23. The lead screws 15 are made of metal, for example, lead, aluminium or steel.

The lead screw 15 which is along the vertical axis can comprise a casing 12 dedicated to this axis, as well as to the support of the airbrush printing tool 7, of the hopper, of the reservoir, which is moved vertically simultaneously relative to the sheet.

Advantageously, elements for guiding in linear translation 13 are coupled to at least one of the lead screws 15.

These guide elements 13 are sliding linear rails or bars, parallel to the lead screws. Supports 29 attach the sliding rails to each motor and coupler elements 31 couple the outputs of each motor 11 to the lead screw 15 by clamping the lead screw 15 onto the shaft of the motor 11. Furthermore, on each lead screw 15, two linear bearings 33 drive, i.e. raise and descend, or advance and move back, the rail 13.

For each lead screw 15, a bearing 37 allows the lead screw 15 to smoothly rotate, for example, a smooth bearing or a ball bearing.

According to an embodiment, three orthogonal lead screws each extending respectively along one of the three orthogonal axes and each of said lead screws is coupled to one of the three drive motors 11 of the airbrush printing tool and is designed to rotate said lead screws.

In an embodiment, the motors 11 are controlled by a control circuit module 41, having an electronic board 43, comprised in a protective casing 25 and coupled to the control panel 23. The module 41 can, for example, take its movement instructions from the control panel 23 or from the electronic board 43, the latter interpreting the representation given by the control panel 23 into movement instructions of the airbrush printing tool 7 relative to the sheet.

The lead screws can be held in their respective axial positions thanks to aluminium frame structural supports 3, 39, 45.

The frames 3, 39, 45 comprise, for example, a substantially horizontal frame 3. This horizontal frame 3 serves as a base to the device 1.

For example, furthermore, a front/rear frame 39 is provided, having two flaps 5 joined by a left/right frame 6 which structure the assembly.

The assembly of the frames 3, 39, 45 is fixed by fixing means 44 which are all standard. The device 1 can thus be fully dismounted.

The device 1 can furthermore comprise a support 49 for the platen 9, comprising five aluminium profiles bolted to the horizontal frame 3. The support 49 is mounted on the horizontal frame 3 itself mounted on feet 53, which can be used to assist with levelling the platen 9 relative to the horizontal. They also give an adherence to the surface on which the device 1 is placed. They are, for example, made of rubber. They can comprise a thread to be adjusted in height by screwing in the support 49 and/or in the horizontal frame 3.

A cable path 42 can be provided, designed to hold the electric cables of the motors 11 at a distance from the platen 9 such that said cables do not come into contact with said platen 9 during movements of the airbrush printing tool 7.

The rotations of each lead screw allows to move the hopper for the airbrush printing along its axis which is orthogonal to the axes of the other lead screws.

Each frame 3, 39, 45 supplies a support to a lead screw 15 and its motor 11. Any contact can therefore be avoided with the sheet during transverse movements of each motor 11 and its lead screw 15, which is made possible by the cable path 42 which hold all the wires in place while the device is moved.

A dosing hopper located downstream from the reservoir allows to automatically adjust the concentrations of ash and ink, according to the desired effect, for example.

The terms “upstream” and “downstream” are defined relative to the direction of circulation of the ink and of the ash in the airbrush printing tool. When two elements are connected, this means that the ink or ash can circulate between these two elements.

Different types of ink can be used, such as described below. Ash can be mixed with ink by the hopper to be able to adjust the concentration of ash.

The dosing hopper can comprise a funnel-shaped container (conic, wedge-shaped, pyramidal, etc.), a first ink reservoir and a second ash reservoir, upstream from the funnel-shaped container. These two reservoirs can be used to store the ash and the ink for graphic printing. These two reservoirs can each be connected to the hopper, more specifically to the funnel-shaped container, so as to supply it with ink and ash separately. The container of the hopper can furthermore contain a membrane disposed, for example, vertically so as to separate the two compounds. The walls of the hopper, as well as the membrane define two chambers, each chamber comprising one of the two compounds, i.e. the ink and the ash. Each compound can then be discharged into the reservoir 21 by dosing means connected to each chamber. Each dosing means, located in the lower part of the funnel-shaped container, discharges the desired quantity of each compound to the reservoir 21 or to a mixer, located downstream from the funnel-shaped container, to finally be discharged into the reservoir 21.

During the discharging of the two compounds into the reservoir 21, it is not always necessary to mix, as the two compounds tend to be automatically mixed. However, in certain cases, it can be advantageous to provide an additional mixer.

The dosing hopper and more specifically the dosing means can furthermore be connected to a control system, allowing to control the concentrations of ink and of ash supplied to the reservoir before spraying onto the support.

The ash in the reservoir can be in powder form.

The dosing means for the ash can thus comprise a powder dosing system. The ash is retained in the chamber of the hopper and are delivered to the reservoir 21 or in the mixer, upstream from the reservoir 21, per time unit, for example by a worm screw (such as an Archimedes' screw), the rotation speed of which is adjustable.

The dosing means can also be supplied by volumetric and gravimetric dosers. The screw volumetric dosers are equipped with a spiral which serves to both measure the volume and to discharge the product upon each rotation. The advantage of this type of doser is that the volume is identical to each cycle (for example, upon each rotation of the spiral) and that the product density is regular. Single-screw, double-screw and triple-screw dosers can be used. For gravimetric dosers, ash is stored in a chamber in the hopper connected to a dynamic scale which permanently measures its weight which allows a very accurate dosing.

Ash can also be ground beforehand to obtain a finer powder and a finer image after airbrush printing with less grains. Ash can be ground by grinding means, such as at least one from among a pestle and mortar, by ultrasound, by a grinding mill or by a ball mill. The second reservoir comprising ash can furthermore be provided with a grinding mill. One or more dispersants can be added during grinding to stabilise the dispersion of ash in the liquid for graphic printing.

The grinding means can be integrated in the container comprising the ash or in the chamber comprising the ash.

The ash supplied in the ash reservoir can be mixed beforehand with a solvent or with water and optionally, a binder to supply the ash in the form of a liquid, paste or gelatine medium. The dosing means can be supplied by volumetric and gravimetric, piston, membrane, valve and peristaltic dosers to the mixer.

The use of a binder allows to fix the ash particles onto the printed image. The binder can be mixed with the ash supplying medium and/or be present in one or more inks.

Different types of inks can be used. Printing can be done by one or more inks, for example with different colours. A device can be used to adjust the mixture of two or more inks.

Different types of inks and paints can be used, like solvent, oil, water, ultraviolet drying inks, acrylic, watercolour paints, Indian inks, etc. The colours can be obtained by organic and/or inorganic colourants and/or pigments. Different graphic effects can be obtained by using inks with special effects, like fluorescent inks, metallic inks, etc.

The dosing means for the ink comprise, for example, volumetric and gravimetric, piston, membrane, valve and peristaltic dosers.

To control the sought final appearance, the concentration of ash and one or more inks can be designed automatically by adjusting the flow rates of the dosing means for inks and for ash. The dosers can be numerically controlled, allowing a permanent adaptation of the concentrations of ash and inks during airbrush printing.

The ash dosing means (or ash supplying medium) and ink dosing means can be used combined with a mixer such that a homogeneous distribution of ask and ink is obtained.

The reservoir is furthermore connected to a nozzle. The diameter of the nozzle can be adapted to the dimension of the ash. A needle is furthermore fixed to the nozzle. The diameter of the needle can also be adapted to the dimension of the ash. For example, if the ash is ground, a finer needle can be used. The final result on the representation will also be finer. The diameter of the needle and of the nozzle can be, for example, comprised in the interval from 0.1 to 0.8 mm, or more specifically, 0.2, 0.3, 0.4, 0.5, 0.6, 0.7 mm. In certain cases, the diameter can be 0.9 or 1 mm.

An active circulation device can be supplied to avoid the deposition of ash particles, for example by sedimentation, once mixed with ink and/or with a solvent and/or with water.

During airbrush printing, a stencil can be used.

Graphic printing can be done on absorbent supports like paper, textile, tiles, wood, terracotta, etc. and on non-absorbent supports like metal, plastics, glass, ceramic, etc. To obtain a better graphic quality and a good adhesion of the image onto the support, the support can be treated beforehand. The support can be cleaned with one or more solvents and/or be activated with a plasma, corona, UV, gamma ray and/or flame treatment. A primer layer can be applied onto the support. To increase the durability of the image and fix the ash particles, a finishing layer can be applied onto the image, and/or a varnish and/or a plastic film, optionally laminated, and/or a glass plate.

Graphic printing can be done on flat objects, as well as on three-dimensional objects and on objects obtained by 3D printing.

After graphic printing, different drying, fixing and soaking treatment can be done by thermal ovens, infrared lamps, UV lamps, etc.

Graphic printing can be combined with other graphic techniques and printing systems, like inkjet, pad printing, flexography, etc.

After mixing, ash or ash supplying medium comprising one or more inks, the mass concentration of the ash is preferably between 0.1% and 10%, and more preferably, between 0.5% and 5%, and even more preferably, between 1% and 3%. The concentration can be varied during graphic printing to obtain different aesthetic effects.

In the printed image, the quantity of ash is preferably between 0.001 g/m² and 1 g/m² and more preferably, between 0.01 g/m² and 0.1 g/m². In the printed image, the quantity of ash can be varied to obtain different aesthetic effects.

Graphic printing with a mixture comprising ash and ink is not limited to airbrush printing, but other printing technologies, like inkjet, pad printing, flexography, and heliography can also be used. In particular, the dosing hopper can be used for different printing systems, so as to supply this mixture.

The device according to the present invention can be controlled by a computer program to print a graphic representation. A person wishing to print a graphic representation can supply to the printing service, a digital image of the graphic representation.

The method comprises the following steps:
supplying a digital image of a representation,
supplying a support,
supplying ink in the first reservoir,
supplying ash in the second reservoir,
starting the printing process by the control panel.

The ash can furthermore be ground during the printing process, or before, by the grinding means such as described above.

The method can furthermore comprise the step of mixing the ash with a solvent or with water, and optionally, a binder to supply a liquid, paste or gelatine medium.

Starting the printing process can furthermore comprise an automatic adjustment of the concentrations of ash and/or ink in the final mixture.

An app can be downloadable for a user wishing to print an image by the device of the present invention. The user can choose the printing support, as well as the graphic representation to be printed. They can also supply the ash.

After having commanded the print, the user receives the desired print on the chosen support.

The following references known to a person skilled in the art comprise information as regards inks, etc.:

Pigment Handbook: ISBN: 9780471600213

Handbook of Natural Dyes and Pigments: ISBN: 9789380308548

Handbook of Textile and Industrial Dyeing: ISBN: 9781845696962

The Printing Ink Manual: ISBN: 9789401170994

Special Effect Pigments: ISBN: 9783866309050

1. A device for airbrush printing a representation on a support, such as a sheet of printing paper, comprising a control panel, in which said representation is digitally stored, a platen of flat shape designed to accept the support, an airbrush printing tool designed for airbrush printing comprising a hopper and a reservoir designed to take ash and ink to be mixed by the hopper, the airbrush printing tool being designed to be able to create airbrush prints using the mixture contained in said reservoir and supplied by the hopper, the airbrush printing tool furthermore being mounted with the ability to move along three orthogonal axes relative to the platen and numerically controlled in its positions along said three axes by the control panel to allow the airbrush printing of the digital representation onto the support, in which the hopper is a dosing hopper designed to adjust the concentration of ash and of ink in the reservoir.

2. The device according to claim 1, in which the dosing hopper comprises a funnel-shaped container, a first and a second reservoir, the first reservoir being configured to take ink, the second reservoir being configured to take ash, the first and second reservoir being located upstream from the funnel-shaped container.

3. The device according to claim 2, in which the dosing hopper comprises a membrane disposed so as to supply a first and a second chamber, the first chamber being connected to the first reservoir, the second chamber being connected to the second reservoir.

4. The device according to claim 3, in which the first chamber is connected to the reservoir by a first dosing means, and the second chamber is connected to the reservoir by a second dosing means.

5. The device according to claim 4, in which the first dosing means for the ink comprises the at least one from among a volumetric doser, a gravimetric doser, a piston doser, a membrane doser, a valve doser and a peristaltic doser.

6. The device according to claim 4, in which the second dosing means for the ash comprises at least one from among a powder dosing system, preferably a worm screw, a volumetric doser, a gravimetric doser, and when the ash is in a liquid, paste or gelatine medium, the second dosing means comprise at least one from among a volumetric doser, a gravimetric doser, a piston doser, a membrane doser, a valve doser and a peristaltic doser.

7. The device according to claim 1, in which the dosing hopper is connected to control means configured to control the concentrations of ink and of ash in the final mixture, more specifically in which the first and second dosing means are configured to be controlled by the control means.

8. The device according to claim 1, furthermore comprising a mixer disposed downstream from the dosing hopper and upstream from the reservoir.

9. The device according to claim 1, in which the reservoir is a cylinder or a pipe connected to a nozzle.

10. The device according to claim 1, in which the airbrush printing tool is configured to be able to be moved horizontally and vertically along lead screws and using in-position servo commands sent by the control panel.

11. The device according to claim 10, furthermore comprising elements for guiding in linear translation coupled to at least one of the lead screws.

12. The device according to claim 1, comprising three orthogonal lead screws, each extending respectively along one of the three orthogonal axes and each of said lead screws being coupled to three drive motors designed for the rotation of said lead screws.

13. The device according to claim 12, in which the motors are controlled by a control circuit module having an electronic board, coupled to the control panel.

14. The device according to claim 12, in which the lead screws are held in their respective axial position, thanks to aluminium frame structural supports.

15. The device according to claim 14, in which the frames comprise a substantially horizontal frame, and the device furthermore comprises a support for the platen comprising five aluminium profiles bolted to said horizontal frame.

16. The device according to claim 12, furthermore comprising a cable path designed to hold the electric cables of the motors at a distance from the platen, such that said cables do not come into contact with said platen during transverse movements of each motor and of its lead screw along the orthogonal transverse axes of the other lead screws, said movements being generated by the rotations of said other lead screws to move the hopper for the airbrush printing.

17. The device according to claim 1, in which the platen is designed to take a support, such as printing paper, preferably in the standard format of 297 millimetres×420 millimetres, or the at least one from among the flat objects, as well as on three-dimensional objects and on objects obtained by 3D printing.

18. The device according to claim 1, in which the platen is designed to take absorbent supports like paper, textile, tiles, wood, terracotta, etc., and non-absorbent supports like metal, plastics, glass, ceramic, etc.

19. Use of the device according to claim 1, for airbrush printing a representation onto a sheet of printing paper, onto a flat or three-dimensional object, an absorbent or non-absorbent support, with an ash and ink mixture.

20-30. (canceled)
